(19) United States
(12) Patent Application Publication
(10) Pub. No.: US 2005/0162727 A1
(43) Pub. Date: Jul. 28, 2005

(54) Micromirrors with support walls

(76) Inventors: Fusao Ishii, Menlo Park, CA (US); Fumitomo Hide, San Jose, CA (US)

Correspondence Address: Fusao Ishii, 350 Sharon Park Drive, G26, Menlo Park, CA, 94025, US

(21) Appl. No.: 10/763,672

(22) Filed: Jan. 24, 2004

(51) Int. Cl. G02F 1/03; G02F 1/07

(52) U.S. Cl. 359/245

(57) ABSTRACT

A micromirror device comprises a reflective element that is supported by at least 1 support wall. Support walls are designed for providing devices with improved mechanical and optical performance. Support walls are supported by a deformable element. The deformable element may be a torsion hinge. The deformable element may be supported by support structures that are designed to limit the deflection of the reflective element. An array of micromirror devices may be used as a spatial light modulator (SLM). Methods of fabricating micromirror arrays comprise the steps of: 1) providing a three-layer substrate, comprising a crystalline layer, a sacrificial layer, and a base layer, with the sacrificial layer being disposed between the crystalline layer and the base layer; 2) forming a deformable element in the crystalline layer; 3) forming support structures for the deformable element; and 4) forming electronic circuits on the base layer.

### TECHNICAL FIELD

This invention relates to micromirror arrays and methods of manufacturing the same. Such arrays have applications in spatial light modulators (SLMs).

### BACKGROUND ART

Electromechanical micromirror devices have drawn considerable interest because of their application as spatial light modulators (SLMs). A spatial light modulator requires an array of a relatively large number of such micromirror devices. In general, the number of devices required ranges from 60,000 to several million for each SLM. Despite significant advances that have been made in recent years, there is still a need for improvement in the performance and manufacturing yields of electromechanical micromirror devices.

U.S. Pat. No. 4,956,619 discloses a prior art micromirror device. In U.S. Pat. No. 4,956,619, the hinge (deflectable element) is formed in the reflecting layer. A problem with this structure is that the hinge has surfaces and edges that cause diffraction of incident light and reduce the contrast ratio. As a result, the optical performance is limited. Another problem is that the material comprising the reflecting layer must be optimized for both optical and mechanical properties.

The former problem of reduced optical performance in U.S. Pat. No. 4,956,619 was addressed by U.S. Pat. No. 5,600,383, which provides an improved micromirror structure in which the reflecting element and the torsion hinge are in separate layers. In this so-called hidden hinge structure, the reflecting element is supported by a support post. The support post connects the reflecting element to an underlying torsion hinge. The torsion hinge is suspended above the base (e.g. substrate) by a hinge gap, which allows the hinge to rotate along an axis of rotation. In a preferred embodiment, the torsion hinge is supported along its axis of rotation by a set of support posts. A 4-pixel micromirror array in accordance with U.S. Pat. No. 5,600,383 is shown in FIG. 2. FIG. 2 is a plan view of a micromirror array 200 comprising 4 reflective elements (202, 204, 206, and 208) and a support post for each reflective element (210, 212, 214, and 216). Each support post is supported by a torsion hinge. The torsion hinges are not seen in FIG. 2 because they are hidden by the reflective elements. When used as a spatial light modulator (SLM), the projection of the incident light propagation vector on the reflective layer plane is given by arrow 220. The rotation axes of the torsion hinges are generally perpendicular to vector 220. For example, for reflective element 206, the corresponding hidden hinge has an axis of rotation given by line B-B′.

FIG. 3 shows a schematic cross sectional view of a micromirror device 300, along line A-A′ of FIG. 2. In summary, a fabrication process according to U.S. Pat. No. 5,600,383 requires 2 spacer layers. The torsion hinge is formed from a structural layer (typically aluminum alloy) that is deposited on a hinge spacer layer. First, a hinge spacer layer is formed by spin-coating a photoresist polymer. Vias are formed in the hinge spacer layer by photolithography. In the subsequent metal deposition, at least 1 aluminum alloy layer is formed in the vias and on the top surface of hinge spacer layer. The metal layer on the hinge spacer layer is patterned to form a torsion hinge, and the metal in the vias form the support posts for the torsion hinge. FIG. 3 shows an element 306, which is the portion of the torsion hinge under the support post. In this case, element 306 is shown to consist of 2 metal layers for better mechanical strength. The hinge metal layer is also patterned to form the addressing electrodes 308 and 310. Then, a mirror spacer layer is formed by spin-coating a photoresist polymer. The mirror spacer layer is patterned to form a via on the torsion hinge, located approximately at the center of mass of the torsion hinge and along its axis of rotation. In a subsequent aluminum alloy deposition step, an aluminum alloy layer is formed in the via and on the top surface of the mirror spacer layer. The metal layer is patterned to form the reflective element 302 and the metal in the via forms the support post 304 for the reflective element.

Note that in this fabrication process, support posts form a depression in the reflective element. This depression lowers the optical performance of the micromirror. This problem can be understood with reference to FIG. 2. Each reflective element has edges 218 located at its outer periphery. In order to reduce diffraction effects, outer edges 218 are oriented at 45° to the incident light vector 220. However, each reflective element also has a depression that is attributed to the support post. This reduces the reflective area of each micromirror. In addition, each reflective element and its support post form edges 220 which can cause diffraction effects. For each reflective element, 2 of the inner edges 220 are perpendicular to the incident light vector.

U.S. Pat. No. 6,038,056 discusses the problem arising from the inner edges and discloses an improved structure in which the inner edges are oriented at 45° to the incident light vector. In some preferred embodiment, contrast was found to increase by 20%.

Optical performance can be improved further by decreasing the cross sectional area of the support posts. The cross sectional area is the area that is exposed to the incident light. D. S. DeWald et al., “Advances in contrast enhancement for DLP projection displays,” Journal of the SID, vol. 11, pp. 177-181 (2003) describe micromirror improvements in which support post cross sectional areas were reduced. According to DeWald, et al., the dimensions of the support post cross section were reduced from 4 μm×3 μm to 2 μm×3 μm; this is a 50% reduction in cross sectional area.

U.S. Pat. No. 5,631,782 discloses an alternative micromirror device that has no vias on the surface of the reflective element. In this case, the reflective element is supported by a support pillar, which typically comprises a UV hardened photoresist covered on the sides and on the top by an Al alloy sheath.

Another problem with many prior art micromirror structures is that Al alloys are used for the structural elements. Al is a ductile metal that undergoes mechanical failure by fatigue. The choice of materials for structural elements in MEMS devices is discussed in V. T. Srikar and S. M. Spearing, “Materials selection for microfabricated electrostatic actuators,” Sensors and Actuators A102 (2003) pp. 279-285. Srikar and Spearing propose that diamond, alumina, silicon carbide, silicon nitride, and silicon are excellent candidates for high-speed, high-force actuators. Studies by Muhlstein et al. on fatigue in polysilicon and monocrystalline silicon have shown that actuators using these materials can cycle up to 10¹¹ cycles in ambient air before failure (C. L. Muhlstein et al., “High-cycle fatigue and durability of polycrystalline silicon thin films in ambient air,” Sensors and Actuators A 94 (2001) pp. 177-188; C. L. Muhlstein et al., “High-cycle fatigue of single-crystal silicon thin films, J. Microelectromechanical Systems, vol. 10 (2001) pp. 593-600). From the production standpoint, however, polysilicon deposition by LPCVD is in the temperature range of 570 to 610° C. Since CMOS circuits with Al cannot withstand temperatures greater than about 400° C., polysilicon deposition must be completed before CMOS processing if the same substrate is to be used.

It is known in the prior art that silicon-on-insulator (SOI) substrates can be used for micromachining structures in which the deformable element is formed from the top silicon layer. SOI substrates are also called SIMOX (Separated by IMplanted OXygen) substrates depending on the substrate manufacturing method. A typical silicon-on-insulator (SOI) substrate comprises an epitaxial top silicon layer with a thickness typically ranging from 50 nm to 600 nm, an intermediate insulator layer (buried oxide layer) with a thickness typically ranging from 50 nm to 2 μm, and a bottom silicon layer (handle wafer) with a thickness of around 775 μm. The top silicon and buried oxide layers exhibit excellent reproducibility and homogeneity over the whole wafer. Therefore, the top silicon layer can be used to form the deformable element and the buried oxide can be used as the sacrificial layer. The advantages of SOI over conventional silicon substrates for micromachining are: smaller number of process steps required for feature isolation (isolation of deformable element); lower parasitic capacitance, and lower power consumption. It is not necessary for the top silicon layer to be an epitaxial layer. For example, in a bonded wafer process, an oxide layer (typically about 1 μm) is grown on a conventional Si wafer. The wafer is then bonded to another wafer, with the silicon oxide sandwiched between.

According to the MEMS Handbook (M. Gad-el-Hak, ed., 2002, CRC Press, Boca Raton, Fla., pp. 16-143-16-144), a conference presentation by B. Diem et al. in 1993 reported a method of micromachining a capacitive pressure sensor from a SOI substrate. First, a 0.2 μm thick epitaxial silicon layer is thickened to a 4 μm thick epitaxial silicon layer. A dry etch access hole is formed in the epitaxial layer, and the buried oxide layer is etched as the sacrificial layer. The dry etch access hole is then filled with a dielectric that is deposited by plasma CVD. This dielectric plug extends from the access hole in the epitaxial layer to the portion of the sacrificial layer under the access hole. A metallization layer is then formed and patterned on the epitaxial silicon layer to define a deformable membrane in the epitaxial layer.

Similarly, U.S. Pat. No. 6,413,793 discusses a fabrication method based on SOI substrates. Major steps in this method include: forming an opening in the structural layer (top epitaxial layer); forming an opening in the sacrificial layer (buried oxide layer); partially filling these opening with a filler material; and patterning the structural layer to form a structural element.

It is known in the prior art that there are some advantages to forming spatial light modulators on the 1st side of a substrate and control circuits on the 2nd side of the same substrate. Such advantages may include lower manufacturing costs or improved light transmission. U.S. Pat. No. 5,510,915 describes an active matrix LCD in which the active matrix is formed on the outer surface of the LCD substrate. Each pixel is connected to its corresponding active matrix circuit by a conductive lead through the substrate. In U.S. Pat. No. 5,537,234, transistor driver circuits are formed on the 1st side of a single crystal silicon wafer, and a liquid crystal cell is formed between the 2nd surface of the silicon wafer and a transparent substrate. U.S. Pat. No. 5,737,052 describes the fabrication of an LCD in which the LCD is on the 1st surface of a substrate, and driver circuits, which can be an integrated circuit fabricated separately from the LCD, are bonded to the 2nd surface of the substrate. U.S. Pat. No. 6,348,991 describes a device in which a spatial light modulator such as liquid crystal on silicon (LCOS) is formed on the 1st surface of a support and a processor is formed on the 2nd surface of the support.

FIG. 4 is a schematic perspective diagram of a support post 400 according to the prior art. For reference, a Cartesian coordinate system 402, with x, y, and z axes is shown. The dimension in the z direction is the height H of the support post. Generally the z direction can be easily identified because the downward force of the load is primarily along the z axis. The dimensions of the support post in the x and y directions are its widths and are labeled Wₓ and W_{y}, For convenience, we choose the x and y axes so that W_{y}≧Wₓ and define the anisotropy of a post as the ratio W_{y}/Wₓ. According to DeWald et al., earlier prior art micromirror devices had cross sections of 4 μm×3 μm (anisotropy=1.33) and later devices had cross sections of 2 μm×3 μm (anisotropy=1.5).

Examples of support posts are also known in house construction. In wood frame construction, support posts are load bearing structural elements. In braced-frame construction, the posts are 4 in.×6 in. (anisotropy=1.5) to 6 in.×8 in. (anisotropy=1.33), and in balloon-frame and platform-frame construction, the posts are typically 4 in.×6 in. (anisotropy=1.5) (from M. Krieger, Homeowner's Encyclopedia of House Construction, McGraw-Hill, New York, pp. 308-313.). These anisotropy values are similar to those of support posts that are used in prior art micromirror devices.

In house construction, load bearing structural elements other than support posts are available. For example, foundation walls support the superstructure (structure of the house above the ground) (from F. D. K. Ching and C. Adams, Building Construction Illustrated, John Wiley & Sons, New York, p. 3.10). As another example, brick walls support the house above ground (M. Krieger, pp. 21-22). Therefore, walls are also widely used load bearing structural elements.

A support wall is shown schematically in perspective in FIG. 5. For convenience, a Cartesian coordinate system 502 with x, y, and z axes is shown. Support wall 500 is characterized by 3 dimensions: a height H, along the z axis, and a thickness T and a length L. As with support posts, the height H, which is along the z axis, can be readily identified because the downward force of the load is primarily along this direction. Furthermore, a wall is unique and distinct from a support post in that its length L is substantially greater than its thickness T.

### SUMMARY OF THE INVENTION

The present invention relates to micromirror devices and arrays of micromirror devices. Such arrays may be used as spatial light modulators (SLMs). In one aspect, the present invention provides a micromirror device in which the reflecting element is supported by a support structure comprising at least 1 wall. Said support structure is mechanically robust and lightweight. As a result, the micromirror device has superior mechanical properties. Another feature of support structures comprising support walls is that the orientation of the walls with respect to the incident light can be adjusted to reduce diffraction. Yet another feature of support structures comprising support walls is that the area of the portions of support structures that are exposed to incident light can be reduced or eliminated. As a result, the contrast ratio of the spatial light modulator (SLM) can be improved.

In another aspect, the present invention provides a micromirror device comprising a reflecting element, a support structure for said reflecting element comprising at least 1 support wall, and a deformable element. The support structure connects the reflecting element to the deformable element. The material for the deformable element is a polycrystalline or monocrystalline semiconductor. In a preferred embodiment, the deformable element is a torsion hinge. In a preferred embodiment, the semiconductor is silicon. The use of a polycrystalline or monocrystalline semiconductor as the material for the deformable element improves the fatigue strength of the deformable element. As a result, the reliability of the spatial light modulator (SLM) is improved.

In yet another aspect, the present invention provides a micromirror device comprising a reflecting element, a support structure for said reflecting element comprising at least 1 support wall, a deformable element, and support structures for said deformable element. Furthermore, the support structures for the deformable element limit the deflection of the reflecting element. This device structure simplifies the micromirror fabrication process while preventing the reflecting element from contacting the addressing electrodes.

In yet another aspect, the present invention provides a method of fabricating an array of micromirror devices, comprising the steps of:
1) providing a 3-layer substrate, comprising a 1st layer, a 2nd layer, and a 3rd layer, with the 2nd layer being disposed between the other layers;
2) patterning the 3rd layer to form deformable elements;
3) forming support structures for the deformable elements;
4) removing at least a portion of the 2nd layer to form a gap between the deformable elements and the 1st layer;
5) forming a support structure comprising at least 1 support wall on each deformable element; and
6) forming reflecting elements, such that each is supported by a support structure comprising at least 1 support wall.

In a preferred embodiment, the 3-layer substrate is a silicon-on-insulator (SOI) substrate, and the 3rd layer is the epitaxial silicon layer. In this case, the deformable element consists of epitaxial silicon, which is essentially monocrystalline silicon. An advantageous feature of this method is that monocrystalline silicon is used as the material for the deformable element. This improves the lifetime of the deformable element. In a preferred embodiment, addressing circuits and addressing electrodes are provided on the substrate during the aforementioned fabrication process. Circuits may be fabricated on the side of the substrate closer to the deformable elements or on the side farther away from the deformable elements or on both sides of the substrate. In a preferred embodiment, circuits may require Al or Al alloy metallization (e.g. CMOS circuits) and support structures for the deformable and reflecting elements are fabricated from polycrystalline silicon. Generally, the steps of depositing polysilicon are performed before the steps of Al or Al alloy metallization.

### BRIEF DESCRIPTION OF FIGURES

The present invention is described in detail below with reference to the following Figures.

FIG. 1 is a schematic diagram of a 4-pixel array of micromirror devices, comprising control circuits, addressing electrodes, and micromirrors.

FIG. 2 is a plan view of a prior art 4-pixel array of micromirror devices.

FIG. 3 is a cross sectional diagram of a micromirror device, along line A-A′ of FIG. 2.

FIG. 4 is a schematic perspective diagram of a prior art support post.

FIG. 5 is a schematic perspective diagram of a support wall in accordance with the present invention.

FIGS. 6A-6L are schematic plan views of support wall structures in accordance with the present invention.

FIGS. 7A-7C are schematic plan views of support wall structures and their orientation with respect to incident light, in accordance with the present invention.

FIG. 8A is a schematic plan view of a micromirror device in accordance with the present invention.

FIG. 8B is a cross sectional diagram of a micromirror device, along line C-C′ of FIG. 8A.

FIGS. 9A-9B are schematic plan views of 4-pixel arrays of micromirror devices, in accordance with the present invention.

FIGS. 10A-10D illustrate some of the steps in the fabrication of a deformable element in accordance with the present invention.

FIGS. 10E-10G are schematic plan views of support structures for deformable elements in accordance with the present invention.

FIG. 11A-11C are plan and side views of a micromirror device illustrating the deflection limiting mechanism in accordance with the present invention.

FIGS. 12A-12E illustrate some of the steps in the fabrication of a micromirror device in accordance with a 1st preferred embodiment of the present invention.

FIGS. 13A-13F illustrate some of the steps in the fabrication of a micromirror device in accordance with a 2nd preferred embodiment of the present invention.

### DESCRIPTION OF PREFERRED EMBODIMENTS

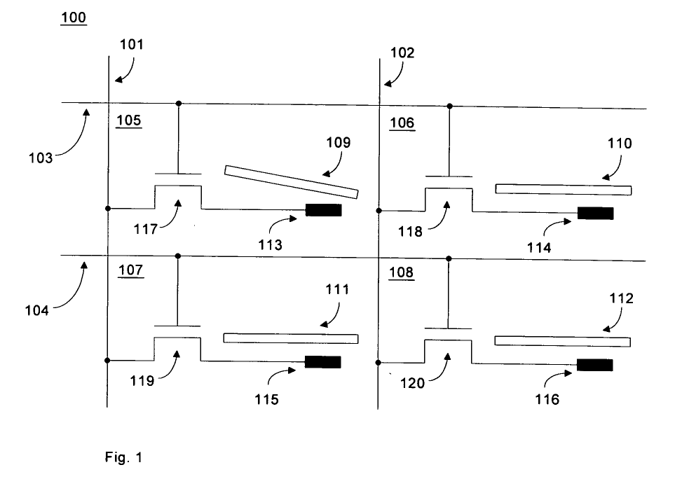

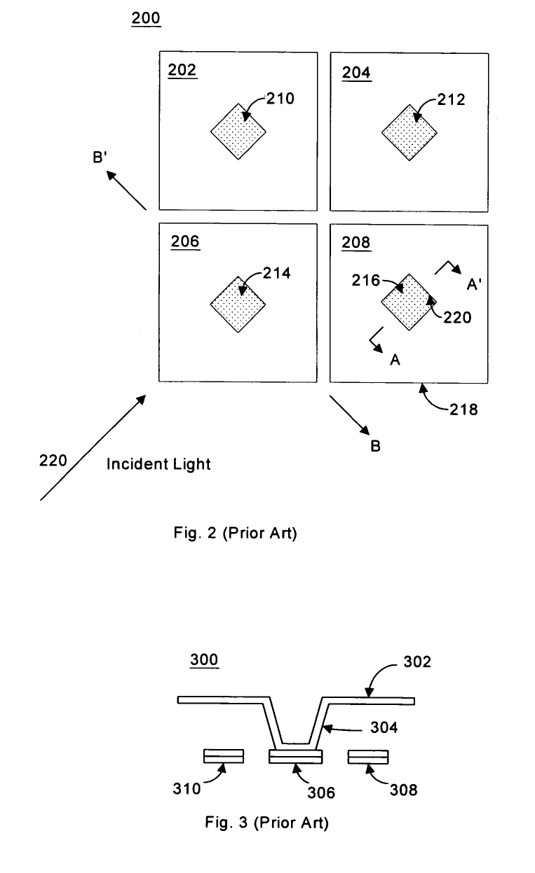

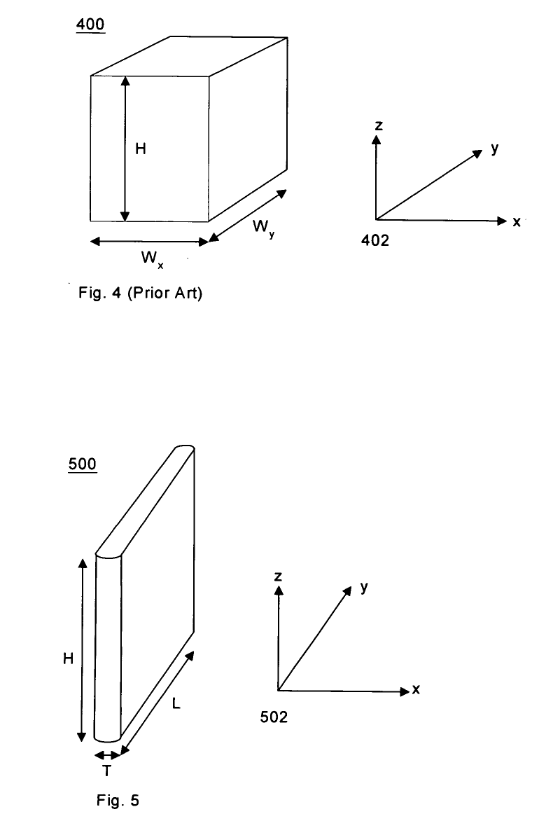

The present invention relates to electromechanical micromirror devices and arrays of such devices. Shown schematically in FIG. 1 is an array 100 comprising vertical data lines (101 and 102) and horizontal addressing lines (103 and 104), with each intersection of these data and addressing lines forming an electromechanical micromirror device (105, 106, 107, and 108). Each micromirror device comprises a micromirror (109, 110, 111, and 112), an addressing electrode (113, 114, 115, and 116), and an NMOS transistor (117, 118, 119, and 120). Micromirror 109 is shown to be in a deflected state while the other micromirrors are in their undeflected states. A possible scheme for addressing the micromirrors is as follows: The micromirrors (109, 110, 111, and 112) are electrically connected to ground. The deflection of a micromirror is determined by the bias voltage between the micromirror and its addressing electrode. The desired bias voltage is set by the voltages on the vertical data lines (101 and 102). The NMOS transistors are turned on by sending a voltage pulse on the addressing lines (103 and 104), which results in the bias voltages being stored between the micromirrors and addressing electrodes.

While array 100 (FIG. 1) has been shown to consist of 4 micromirror devices, an array may typically consist of greater than 60,000 micromirror devices and may be used as a spatial light modulator (SLM). Furthermore, while FIG. 1 shows a plurality of micromirror devices disposed in a 2-dimensional array, 1-dimensional (linear) arrays are also possible.

The circuitry as shown in FIG. 1 comprises the following:
1) micromirrors;
2) micromirror addressing electrodes; and
3) control circuitry.
   In the particular case of FIG. 1, control circuitry consists of the vertical data lines (101 and 102), horizontal addressing lines (103 and 104), NMOS transistors (117, 118, 119, and 120), and electrical connections among them. In general, control circuitry is understood to mean any circuitry that is provided to control the application of bias voltages between a micromirror and its addressing electrode. The control circuitry of FIG. 1 comprises NMOS transistors. However, it should be understood that the control circuitry could comprise other types of circuits, including CMOS circuits, PMOS circuits, bipolar transistor circuits, BiCMOS circuits, DMOS circuits, HEMT circuits, amorphous silicon thin film transistor circuits, polysilicon thin film transistor circuits, SiGe transistor circuits, SiC transistor circuits, GaN transistor circuits, GaAs transistor circuits, InP transistor circuits, CdSe transistor circuits, organic transistor circuits, and conjugated polymer transistor circuits.

In the present invention, the reflective element is supported by a support structure comprising at least 1 support wall. An exemplary wall is shown in FIG. 5. For convenience, a Cartesian coordinate system 502 is shown with x, y, and z axes. Wall 500 is characterized by a height H, a thickness T, and a length L. Height H, which is along the z axis, can be readily identified because the downward force of the load is primarily along this direction. Similarly, length L and thickness T can also be readily identified because they are substantially perpendicular to height H and length L is substantially greater than thickness T. It is not necessary for a wall to have uniform dimensions (L, T, and H). For example, the thickness at the bottom of the wall may be greater than the thickness at the top of the wall.

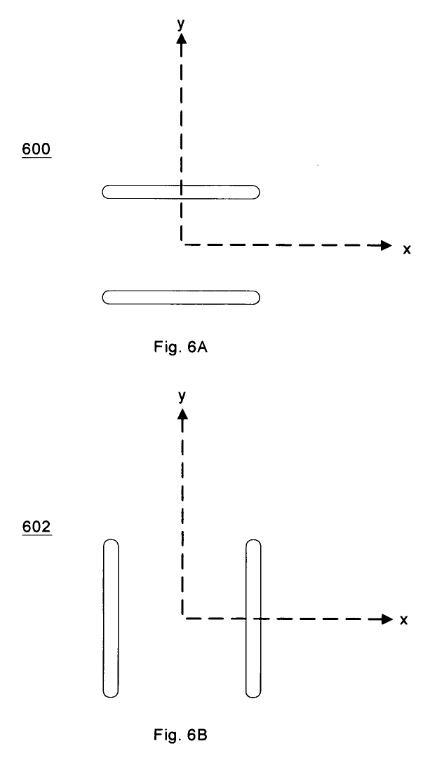

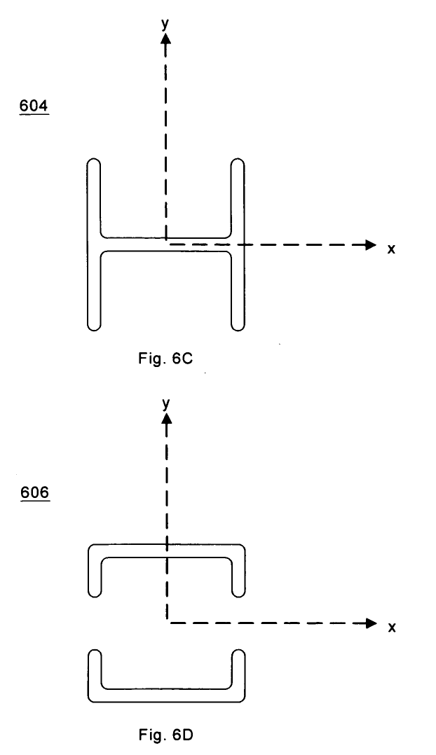

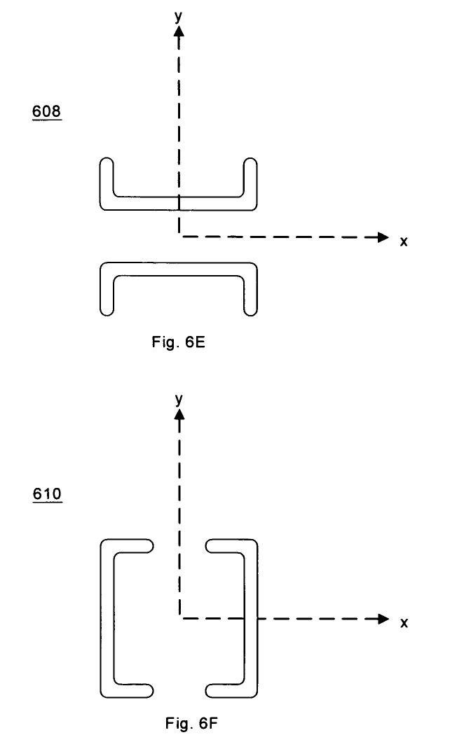

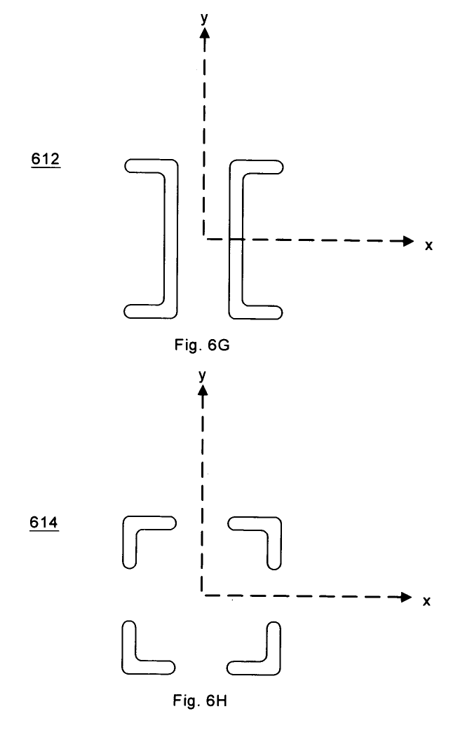

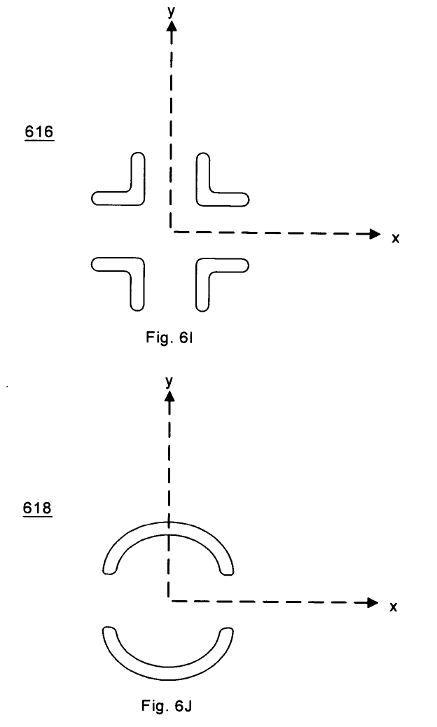

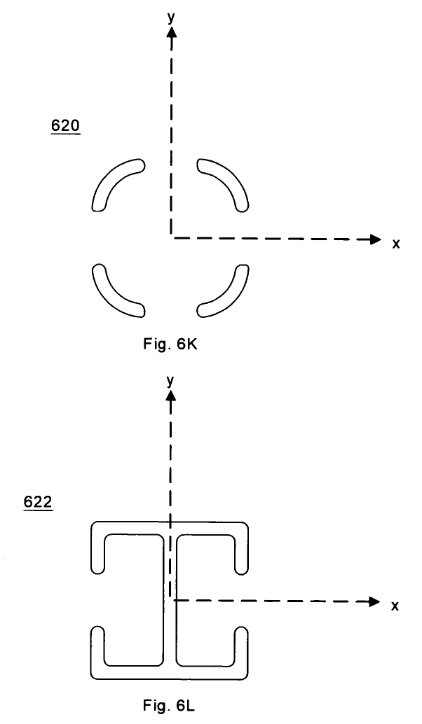

FIGS. 6A-6L are schematic plan views of exemplary walls in accordance with the present invention. In each figure, a Cartesian coordinate system defined by x and y axes is shown. The origin of the coordinate system corresponds approximately to the center of mass of the wall structure. It is possible to relate the x and y axes to the structure of micromirror devices. For example, support walls may be fabricated on a torsion hinge, with the axis of rotation of the torsion hinge being the y-axis.

FIGS. 6A and 6B each show a support structure (600, 602) comprising 2 separate support walls. These Figures show that there are various possible orientations for support walls. The support structure 604 of FIG. 6C consists of 2 wall segments parallel to the y-axis (similar to that shown in FIG. 6B) with an additional wall segment along the x-axis for additional strength. FIGS. 6D-6G show other exemplary structures (606, 608, 610, 612) with each support structure comprising 2 separate support walls. Each structure comprises 2 walls, and each wall contains a long segment and 2 shorter segments at the ends of the long segment for additional strength. FIGS. 6D-6G illustrate the various possible orientations for these walls. Other orientations are also possible. In addition, FIGS. 6H-6I show exemplary structures (614, 616) with each structure comprising 4 separate support walls. Therefore, a support structure may comprise a plurality of walls, and there are numerous possibilities for the shapes and orientations of the walls.

FIG. 6J shows a support structure 618 comprising 2 curved walls. It is not necessary to use straight walls. Similarly, FIG. 6K shows a support structure 620 comprising 4 curved walls. More complicated support structures are possible. For example, FIG. 6L shows a support structure 622 which consists of 1 long segment and 4 short segments parallel to the y axis and 2 segments parallel to the x axis.

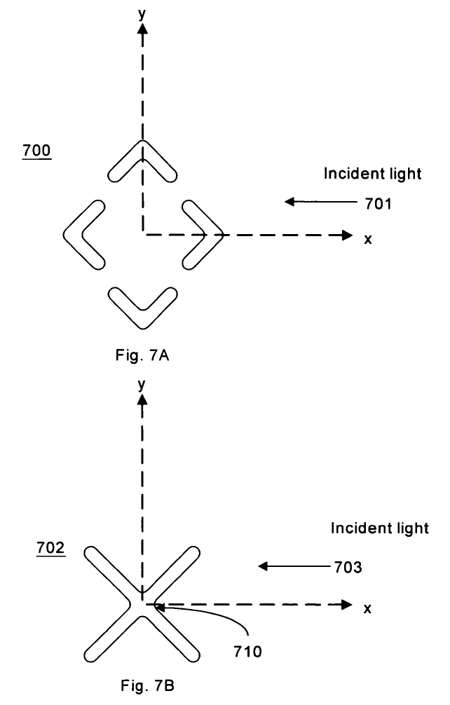

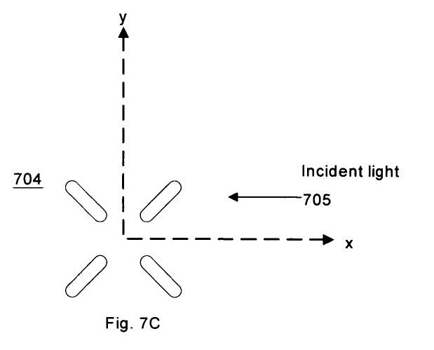

As shown in FIGS. 6J and 6K, it is not necessary for the walls to be parallel to the x or y axes. One of the considerations in the orientation of the walls is the direction of incident light. FIGS. 7A-7C are schematic plan views of support wall structures and their orientation with respect to incident light, in accordance with the present invention. In each case, a Cartesian coordinate system defined by x and y axes is shown, with the origin at the center of mass of the support structure. FIG. 7A shows a support structure 700 comprising 4 separate wall segments. The projection of the incident light propagation vector on the x-y plane is shown as arrow 701. The wall segments of structure 700 are oriented so that they are neither parallel nor perpendicular to arrow 701 and are generally about 45° from arrow 701. Therefore, if the wall segments were exposed to the incident light, diffraction from these wall segments would be less than if the wall segments were perpendicular to arrow 701.

FIG. 7B shows a support structure 702 and incident light vector 703. Support structure 702 comprises 4 connected wall segments all of which are oriented approximately 45° from arrow 703. However, structure 702 contains a region 710 near the origin that may cause some diffraction. FIG. 7C shows an improved structure 704 in which the region near the origin has been removed. Therefore, the wall segments of structure 704 are substantially oriented about 45° from incident light vector 705.

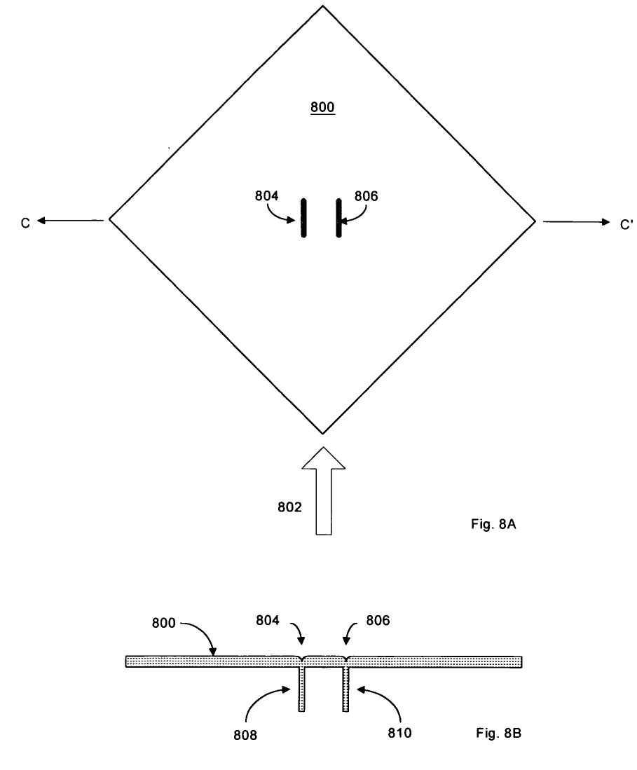

In some preferred embodiments of the present invention, support walls are exposed to the incident light. In some other preferred embodiments, support walls are not exposed to the incident light. In either case, it is important to consider the orientation of the walls relative to the incident light direction. FIG. 8A shows a plan view of a reflective element 800 and an arrow 802 indicating the projection of the incident light propagation direction on the plane of the reflective element. The reflecting element 800 has depressions 804 and 806 arising from support walls that are underneath the reflecting element 800. This is understood by referring to a cross section along line C-C′ of FIG. 8A, which is shown in FIG. 8B. Depressions 804 and 806 arise from support walls 808 and 810 and are artifacts of the fabrication process. In this case, the length direction of the walls is oriented parallel to incident light vector 802. Therefore, diffraction is reduced.

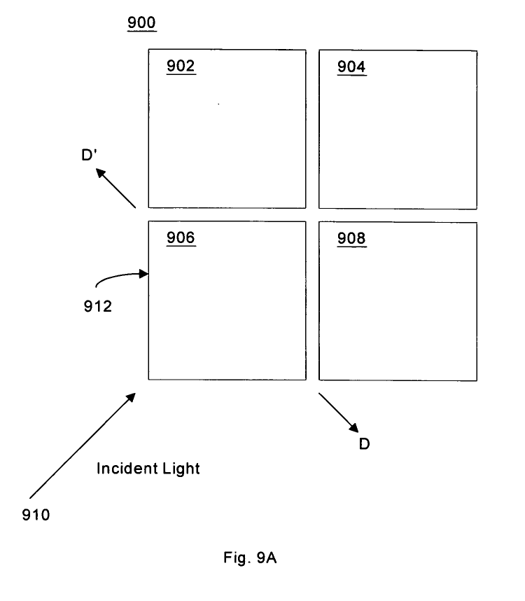

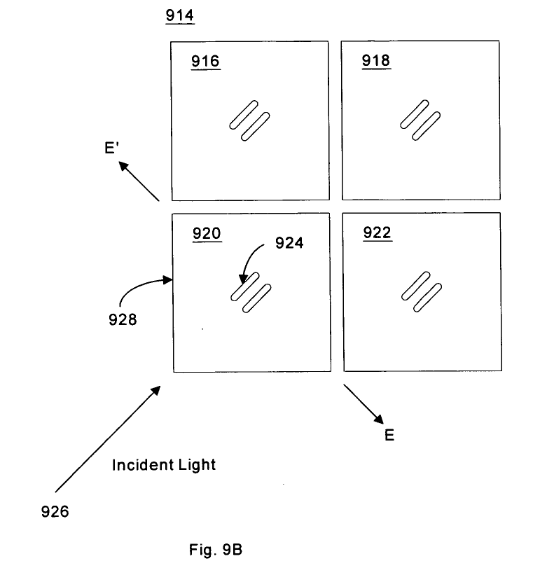

FIG. 9A is a schematic plan views of a 4-pixel array of micromirror devices, in accordance with a preferred embodiment of the present invention. Array 900 consists of reflecting elements 902, 904, 906, and 908. The reflecting elements are shown to have substantially planar surfaces with no observable artifacts (such as depressions or protrusions) arising from underlying support structures. Each reflecting element has outer edges 912. The projection of the incident light propagation direction on the reflecting surface plane is shown by arrow 910. Underneath each reflecting element is a torsion hinge. The axis of rotation of the torsion hinge under reflecting element 906 is given by line D-D′. Similarly, the axes of rotation of the other torsion hinges in the array are parallel to line D-D′. The incident light direction 910 is perpendicular to the axes of rotation and are oriented at 45° with respect to the outer edges 912 of the reflecting elements. In this preferred embodiment, diffraction is minimized by providing a substantially planar reflecting surface and by orienting the outer edges of the reflecting elements at 45° to the incident light direction.

FIG. 9B is a schematic plan view of a 4-pixel array of micromirror devices, in accordance with another preferred embodiment of the present invention. Array 914 consists of reflecting elements 916, 918, 920, and 922. The reflecting elements are shown to have substantially planar surfaces with the exception of exposed portions 924 of underlying support walls. Each reflecting element has outer edges 928. The projection of the incident light propagation direction on the reflecting surface plane is shown by arrow 926. Underneath each reflecting element is a torsion hinge. The axis of rotation of the torsion hinge under reflecting element 920 is given by line E-E′. Similarly, the axes of rotation of the other torsion hinges in the array are parallel to line E-E′. The incident light direction 926 is perpendicular to the axes of rotation and are oriented at 45° with respect to the outer edges 912 of the reflecting elements. Furthermore, exposed portions 924 of underlying support walls are oriented such that the length direction of the walls is parallel to incident light direction 926. In this preferred embodiment, diffraction is minimized by orienting the support walls parallel to the incident light direction and by orienting the outer edges of the reflecting elements at 45° to the incident light direction.

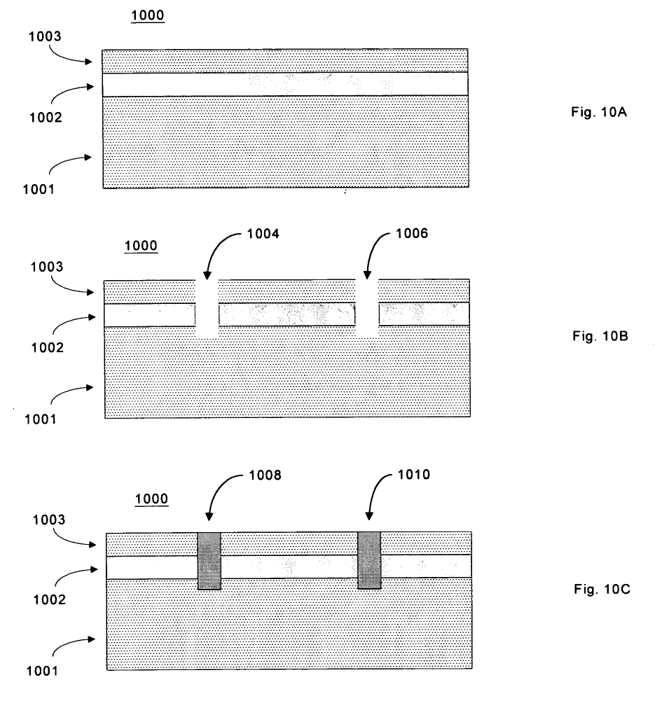

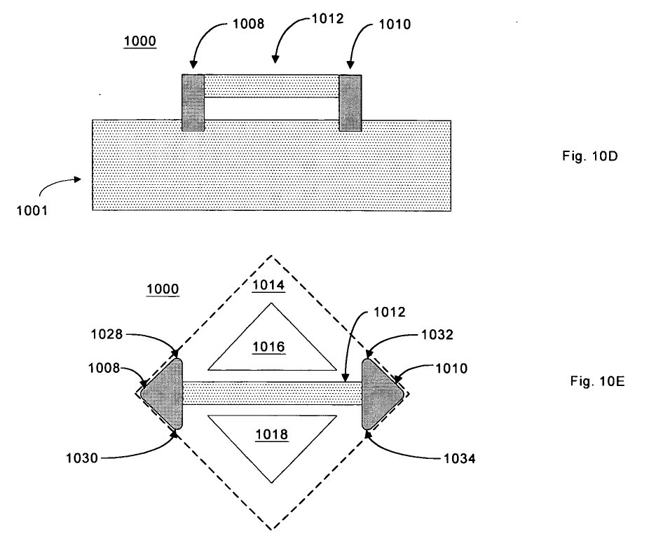

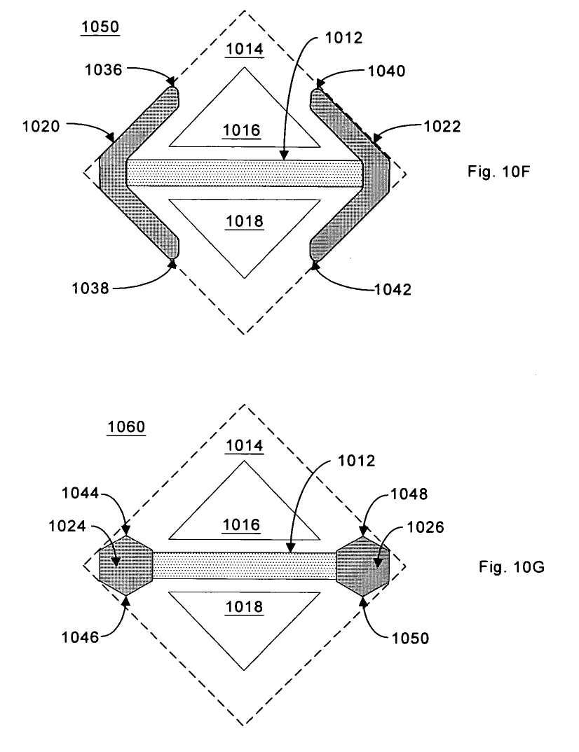

FIGS. 10A-10D illustrate some important steps in the fabrication of a deformable element in accordance with a preferred embodiment of the present invention. In this preferred embodiment, the deformable element is a torsion hinge. For simplicity, the fabrication steps for 1 device are shown. FIG. 10A shows a silicon-on-insulator (SOI) substrate 1000 comprising an epitaxial top silicon layer 1003 with a thickness typically ranging from 50 nm to 600 nm, an intermediate insulator layer or buried silicon oxide layer 1002 with a thickness typically ranging from 50 nm to 2 μm, and a bottom silicon layer or handle wafer 1001 with a thickness of around 775 μm. If necessary, it is possible to increase the thickness of the top epitaxial layer 1003 by performing an additional epitaxial deposition step. It is also possible to use a 3-layer substrate in which the top layer 1003 is polycrystalline silicon instead of epitaxial monocrystalline silicon. In general, the substrate should be a 3-layer substrate in which the top layer is a polycrystalline or monocrystalline semiconductor and the middle layer is a sacrificial layer.

In FIG. 10B, vias 1004 and 1006 are formed in the substrate, extending from top epitaxial layer 1003, through intermediate insulator layer 1002, and partially into bottom silicon layer 1001. As shown in FIG. 10C, vias 1004 and 1006 are filled with a structural material to form support structures 1008 and 1010. In a preferred embodiment, the structural material is polycrystalline silicon. In a preferred embodiment, polycrystalline silicon is deposited by LPCVD and patterned to form structural elements 1008 and 1010. The top surfaces of 1008 and 1010 may also be planarized. Finally, as shown in FIG. 10D, top epitaxial layer 1003 is patterned to define a torsion hinge 1012. Furthermore, as shown in FIG. 10D, a portion of sacrificial layer 1002 is removed which leaves the torsion hinge 1012 supported by structural elements 1008 and 1010. The axis of rotation of the torsion hinge is determined by the support structures 1008 and 1010.

FIGS. 10E-10G are schematic plan views of support structures for torsion hinges in accordance with the present invention. FIG. 10E shows a top view of a torsion hinge upon completion of the step in FIG. 10D. A torsion hinge 1012 is supported by triangular support structures 1008 and 1010. Square region 1014 indicates the area that will subsequently be covered by a reflecting element. Triangular regions 1016 and 1018 are areas where addressing electrodes will subsequently be formed. Support structure 1008 has corners 1028 and 1030 that are positioned to contact the reflecting element and limit its deflection when it is actuated. Similarly, support structure 1010 has corners 1032 and 1034 that are positioned to contact the reflecting element and limit its deflection when it is actuated. This deflection limiting mechanism will be described in detail below.

FIG. 10F shows another partially completed micromirror device 1050 comprising a torsion hinge 1012 supported by support structures 1020 and 1022. These support structures are elongated structures that are somewhat similar to the wall that is described in FIG. 5. Support structure 1020 has corners 1036 and 1038 for limiting the deflection of the reflecting element. Similarly, support structure 1022 has corners 1040 and 1042. The support structures are shaped so that they do not protrude beyond the area 1014 that will be covered by a reflecting element. The length or extent of support structures 1020 and 1022 can be modified to adjust the allowable deflection range of the reflecting element.

FIG. 10G shows another partially completed micromirror device 1060 comprising a torsion hinge 1012 supported by hexagonal support structures 1024 and 1026. Support structure 1024 has corners 1044 and 1046 for limiting the deflection of the reflecting element. Similarly, support structure 1026 has corners 1048 and 1050. The support structures described in FIGS. 10E-10G have corners for limiting the deflection of the reflecting elements. These corners have relatively small areas of contact with the reflecting elements.

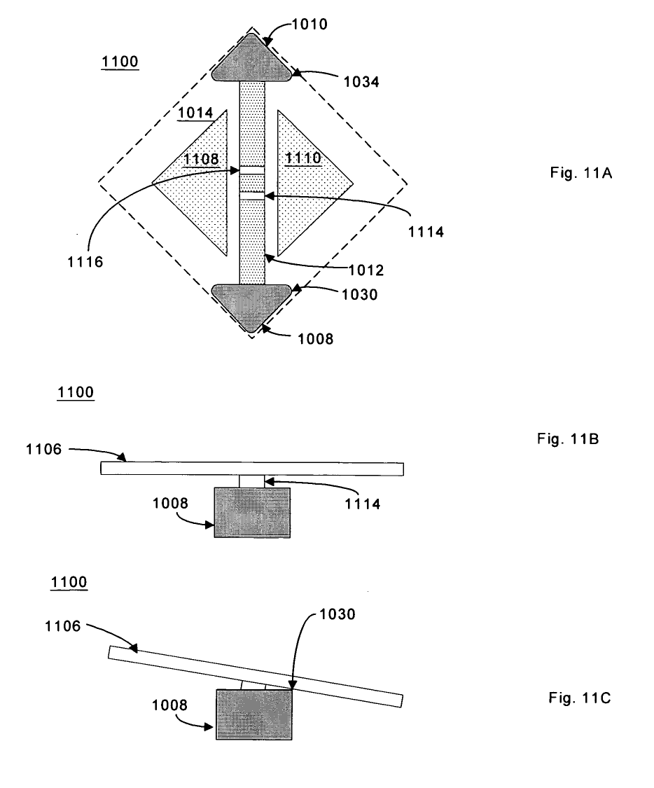

FIG. 11A-11C are plan and elevational views of a micromirror device illustrating the deflection limiting mechanism in accordance with the present invention. FIG. 11A is a top view of a micromirror device 1100 with the reflecting element removed. A torsion hinge 1012 is supported by triangular support structures 1008 and 1010. Support walls 1114 and 1116 are located on torsion hinge 1012. The area that is covered by the reflecting element is shown as region 1014. Addressing electrodes 1108 and 1110 are located on both sides of torsion hinge 1012. FIG. 11B is a front elevational view of micromirror device 1100. A reflecting element 1106 is located on top of support walls 1114 and 1116. The reflecting element 1106 is shown in its quiescent state in FIG. 11B. FIG. 11C shows reflecting element 1106 in an actuated state and its deflection is limited by corner 1030 of support structure 1008. At the same time, the deflection is limited by corner 1034 of support structure 1010, although this is not shown in FIG. 11C. Since the deflection limiting mechanism is provided by the deformable element support structures, there is no need for a separate and distinct deflection limiting mechanism.

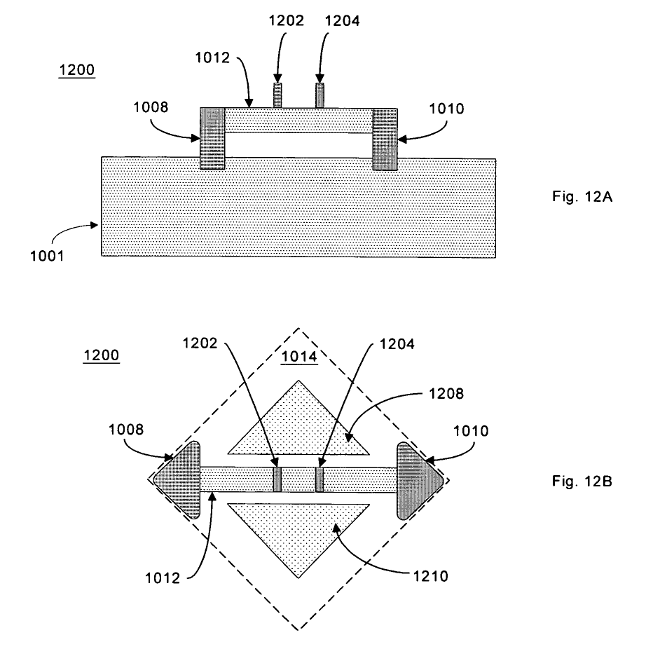

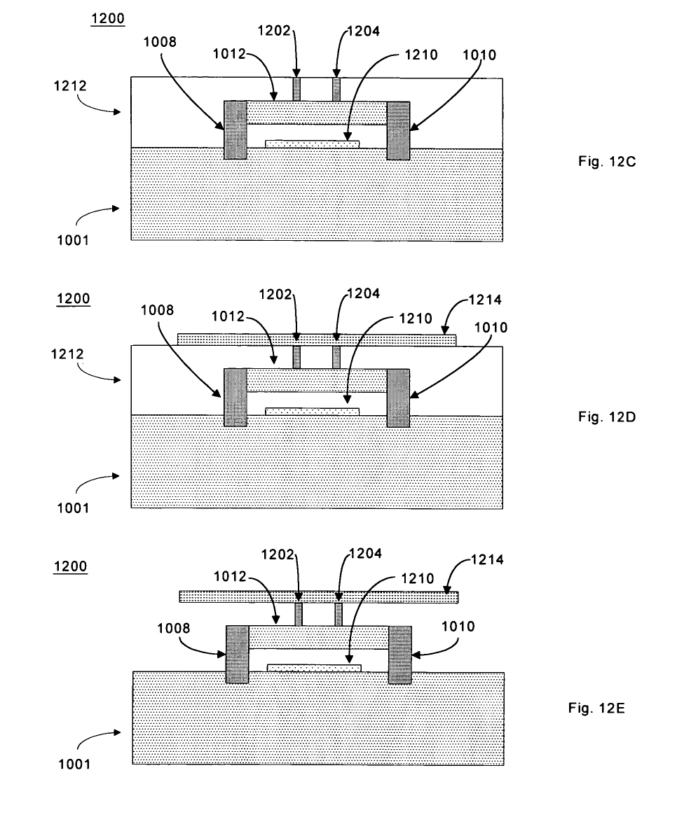

FIGS. 12A-12E illustrate some important steps in the fabrication of a micromirror device 1200 in accordance with a 1st preferred embodiment of the present invention. An important feature of this fabrication method is that the materials for the support walls and the reflecting layer are deposited in different steps. A torsion hinge 1012 is fabricated on an SOI substrate according to the steps outlined in FIGS. 10A-10D. As shown in FIG. 12A, support walls 1202 and 1204 are formed on torsion hinge 1012. In a preferred embodiment, the material for the support walls is polycrystalline silicon. A layer of polycrystalline silicon may be deposited by LPCVD and patterned to form the support walls 1202 and 1204. It is preferable to form the Al alloy metallization layers in addressing circuits after all steps that require high temperature processing such as deposition of polysilicon by LPCVD have been performed. FIG. 12B shows a plan view of a partially completed device 1200. After the formation of the polysilicon support walls, addressing electrodes and control circuits are formed. Generally, addressing electrodes and control circuits are fabricated so that addressing electrodes are closer to the reflecting element. Therefore, in this case, control circuits are fabricated before the addressing electrodes. Control circuits and addressing electrodes are located in regions 1208 and 1210.

A micromirror is electromechanically actuated by providing a voltage between the reflecting element and at least 1 addressing electrode. It is necessary to establish a fixed potential (such as ground potential) at the reflecting element. A preferred material for the support structures for the deformable element (e.g. torsion hinge) is doped polysilicon. Similarly, a preferred material for the support walls for the reflecting element is doped polysilicon. Other preferred materials for these support structures include Al, Al alloys, Mo, W, TiSi₂, WSi₂, CoSi₂, Ti:W (with W being about 10%), TiN, and Cu.

As shown in FIG. 12C, a sacrificial layer 1212 is deposited. Sacrificial layer 1212 and support walls 1202 and 1204 are planarized to provide a substantially planar surface for the deposition of the reflecting layer. For example, planarization can by accomplished by backgrinding and chemical mechanical polishing (CMP). As shown in FIG. 12D, a reflective layer such as Al alloy is deposited on sacrificial layer 1212 and patterned to form a reflective element 1214. The reflectivity of the reflecting element can be increased by depositing a multilayer dielectric stack on top of the Al alloy reflecting layer. Finally, the sacrificial layer 1212 is removed in an etching process, which leaves the reflecting element 1214 supported by support walls 1202 and 1204 (FIG. 12E).

In the fabrication method of FIGS. 12A-12E, the control circuits were fabricated on the same side of the substrate as the addressing electrodes. In other words, the control circuits are located on the same side of the substrate as the spatial light modulator (SLM). It is also possible to place control circuits on the other side of the substrate. Since handle layer 1001 is a silicon layer, its bottom surface can also be used to form circuits. In this case, control circuits and corresponding addressing electrodes may be connected by conducting vias through handle layer 1001. It is also possible to fabricate control circuits on a substrate that is different than the substrate that is illustrated in FIGS. 12A-12E. In subsequent steps, the 2 substrates are combined to form a spatial light modulator (SLM).

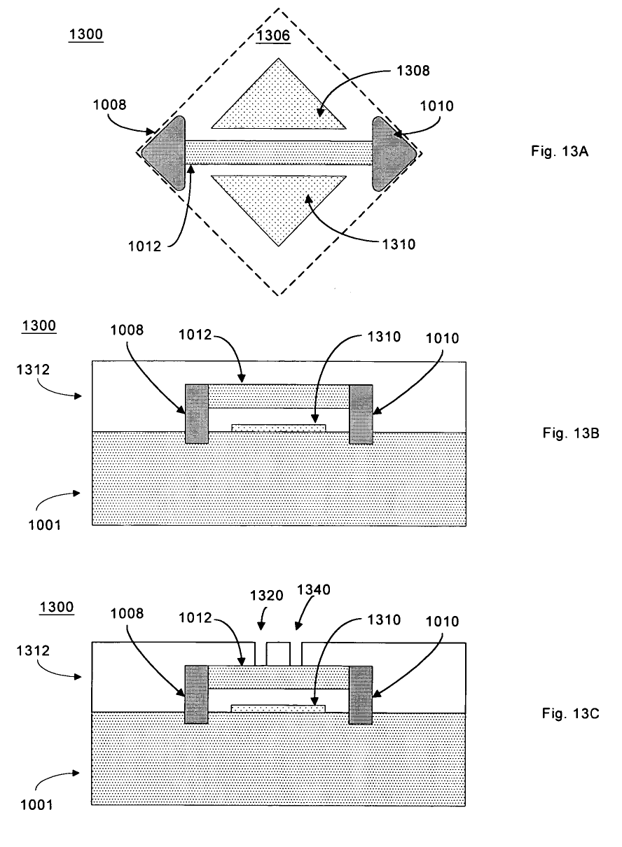

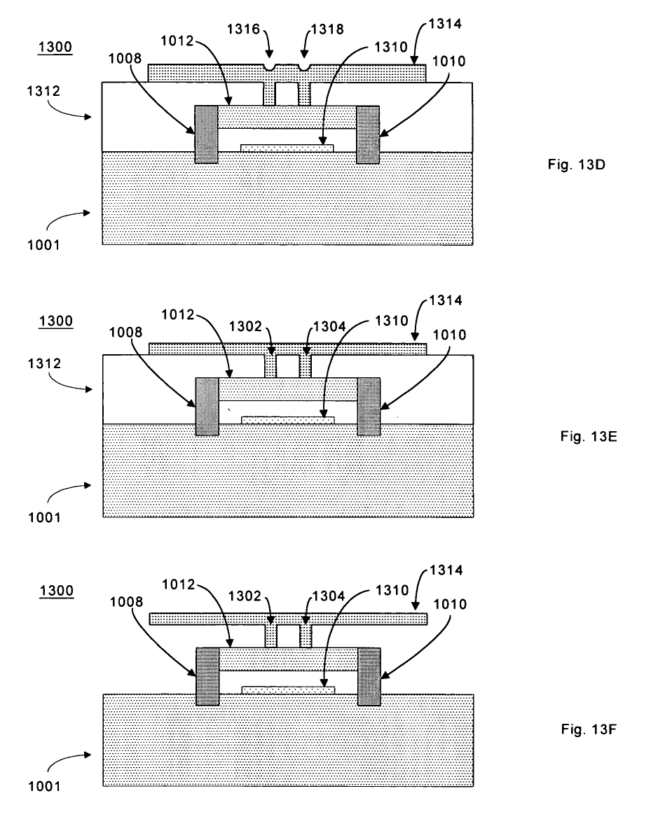

FIGS. 13A-13F illustrate some important steps in the fabrication of a micromirror device 1300 in accordance with a 2nd preferred embodiment of the present invention. An important feature of this fabrication method is that the material for the support walls and the reflecting layer are deposited in the same step. A torsion hinge 1012 is fabricated on an SOI substrate according to the steps outlined in FIGS. 10A-10D. FIG. 13A shows a plan view of a partially completed device 1300, upon completion of addressing electrodes and control circuits (1308, 1310). As shown in FIG. 13B, a sacrificial layer 1312 is deposited and planarized. As shown in FIG. 13C, vias 1320 and 1340 are formed in sacrificial layer 1312, with the vias extending to torsion hinge 1012. A layer of reflective material such as Al alloy is deposited on sacrificial layer 1312 and in the vias 1320 and 1340. The Al alloy in the vias form support walls. The reflective layer is patterned to form a reflective element 1314, as shown in FIG. 13D. FIG. 13D shows depressions 1316 and 1318 corresponding to the locations of the vias. These depressions can be removed by planarization of the top surface of the reflective element. For example, planarization can by accomplished by backgrinding and chemical mechanical polishing (CMP). The result of planarization is shown in FIG. 13E. It may also be possible to planarize the reflective layer before patterning it to form the reflective element, which corresponds to reversing the order of FIGS. 13D and 13E. Finally, sacrificial layer 1312 is removed in an etching process, which leaves the reflecting element 1314 supported by support walls 1302 and 1304 (FIG. 13F). The reflectivity of the reflecting element can be increased by depositing a multilayer dielectric stack on top of the Al alloy reflecting layer.

1. A micromirror device comprising:
a reflecting element that can be deflected into at least 2 states; and
a support structure for supporting said reflecting element, said support structure comprising at least 1 wall.

2. The device of claim 1, wherein said reflecting element comprises at least 1 metallic layer.

3. The device of claim 1, wherein said reflecting element comprises at least 1 semiconductor layer.

4. The device of claim 1, wherein said reflecting element comprises a plurality of dielectric layers.

5. The device of claim 1, wherein the reflective surface of said reflecting element is substantially planar with neither depressions nor protrusions.

6. The device of claim 1, wherein the reflective surface of said reflecting element has no outer edges that are perpendicular to the projection of the incident light propagation vector onto the plane of said reflective surface.

7. The device of claim 1, wherein said at least 1 wall is oriented such that the angle between the projection of the incident light propagation vector onto the plane of the reflective surface of said reflecting element and a wall segment of said at least 1 wall is between 0° and 75°.

8. The device of claim 1, wherein said angle is between 0° and 60°.

9. The device of claim 1, wherein said angle is between 0° and 45°.

10. The device of claim 1, wherein said at least 1 wall is contained in a layer that is separate from the layer that contains said reflecting element.

11. The device of claim 1, wherein said support structure comprising at least 1 wall comprises a material selected from the group consisting of: polycrystalline silicon, monocrystalline silicon, amorphous silicon, Al, Al alloy, Mo, W, TiSi₂, WSi₂, CoSi₂, Ti:W, TiN, and Cu.

12. The device of claim 11, wherein said polycrystalline silicon is doped.

13. The device of claim 11, wherein said monocrystalline silicon is doped.

14. A micromirror device comprising:
a reflecting element that can be deflected into at least 2 states;
a support structure for supporting said reflecting element, said support structure comprising at least 1 wall; and
a deformable element that is connected to said support structure.

15. The device of claim 14, wherein said deformable element is a torsion hinge.

16. The device of claim 14, wherein said deformable element comprises a crystalline semiconductor material.

17. The device of claim 16, wherein said crystalline semiconductor material is selected from the group consisting of polycrystalline silicon and monocrystalline silicon.

18. The device of claim 16, wherein said crystalline semiconductor material is doped.

19. A micromirror device comprising:
a reflecting element that can be deflected into at least 2 states;
a 1st support structure for supporting said reflecting element, said support structure comprising at least 1 wall;
a torsion hinge that is connected to said 1st support structure; and
a 2nd set of support structures for supporting said torsion hinge, said 2nd set of support structures defining an axis of rotation of said torsion hinge.

20. The device of claim 19, wherein each of said 2nd set of support structures comprises at least 1 portion for limiting the deflection of said reflecting element.

21. The device of claim 19, wherein said 2nd set of support structures comprises support structures selected from the group consisting of: triangular structures, polygonal structures, walls, elliptical structures, and circular structures.

22. The device of claim 19, wherein said 2nd set of support structures comprises a material selected from the group consisting of:
polycrystalline silicon, monocrystalline silicon, amorphous silicon, Al, Al alloy, Mo, W, TiSi₂, WSi₂, CoSi₂, Ti:W, TiN, and Cu.

23. The device of claim 22, wherein said polycrystalline silicon is doped.

24. The device of claim 22, wherein said monocrystalline silicon is doped.

25. The device of claim 19, wherein said torsion hinge comprises a crystalline semiconductor material.

26. The device of claim 25, wherein said crystalline semiconductor material is selected from the group consisting of polycrystalline silicon and monocrystalline silicon.

27. The device of claim 25, wherein said crystalline semiconductor material is doped.

28. A micromirror device comprising:
a reflecting element that can be deflected into at least 2 states;
a 1st support structure for supporting said reflecting element, said support structure comprising at least 1 wall;
a deformable element that is connected to said 1st support structure;
a 2nd set of support structures for supporting said deformable element; and
a base layer for supporting said 2nd set of support structures, said base layer having a 1st surface and a 2nd surface, with said 1st surface facing said reflecting element.

29. The micromirror device of claim 28, wherein said base layer comprises a crystalline semiconductor material.

30. The micromirror device of claim 29, wherein said crystalline semiconductor material is selected from the group consisting of polycrystalline silicon and monocrystalline silicon.

31. The device of claim 28, wherein said base layer additionally comprises addressing electrodes for actuating said reflecting element.

32. The device of claim 28, wherein said base layer additionally comprises addressing electrodes for actuating said deformable element.

33. The device of claim 28, wherein said base layer additionally comprises control circuitry.

34. The device of claim 33, wherein said control circuitry is disposed on said 1st surface of said base layer.

35. The device of claim 33, wherein said control circuitry is disposed on said 2nd surface of said base layer.

36. The device of claim 33, wherein said control circuitry is selected from the group consisting of: CMOS circuits, NMOS circuits, PMOS circuits, bipolar transistor circuits, BiCMOS circuits, DMOS circuits, HEMT circuits, amorphous silicon thin film transistor circuits, polysilicon thin film transistor circuits, SiGe transistor circuits, SiC transistor circuits, GaN transistor circuits, GaAs transistor circuits, InP transistor circuits, CdSe transistor circuits, organic transistor circuits, and conjugated polymer transistor circuits.

37. A method of fabricating a micromirror device, comprising the steps of:
providing a 3-layer substrate, comprising a 1st bottom layer, a 2nd intermediate layer, and a 3rd top layer;
patterning said 3rd top layer to form a deformable element;
forming a 1st set of support structures for said deformable element;
removing at least a portion of said 2nd intermediate layer to form a gap between said deformable element and said 1st layer;
forming a 2nd support structure comprising at least 1 wall on said deformable element;
depositing at least 1 reflecting layer, such that it is supported by said 2nd support structure comprising at least 1 wall; and
patterning said at least 1 reflecting layer to form a reflecting element.

38. The method of claim 37, wherein said 3-layer substrate is a silicon-on-insulator (SOI) substrate and said 1st bottom layer is a handle wafer, said 2nd intermediate layer is a buried silicon oxide layer, and said 3rd top layer is a silicon layer.

39. The method of claim 38, wherein said 3rd top layer is an epitaxial silicon layer.

40. The method of claim 37, wherein said 1st set of support structures for said deformable element comprises a material selected from the group of consisting of: polycrystalline silicon, monocrystalline silicon, amorphous silicon, Al, Al alloy, Mo, W, TiSi₂, WSi₂, CoSi₂, Ti:W, TiN, and Cu.

41. The method of claim 40, wherein said polycrystalline silicon is doped.

42. The method of claim 40, wherein said monocrystalline silicon is doped.

43. The method of claim 37, wherein said deformable element comprises a crystalline semiconductor material.

44. The method of claim 43, wherein said crystalline semiconductor material is selected from the group consisting of polycrystalline silicon and monocrystalline silicon.

45. The method of claim 43, wherein said crystalline semiconductor material is doped.

46. The method of claim 37, wherein said deformable element is a torsion hinge.

47. The method of claim 37, wherein said 2nd support structure for said reflecting element comprises a material selected from the group of consisting of: polycrystalline silicon, monocrystalline silicon, amorphous silicon, Al, Al alloy, Mo, W, TiSi₂, WSi₂, CoSi₂, Ti:W, TiN, and Cu.

48. The method of claim 47, wherein said polycrystalline silicon is doped.

49. The method of claim 47, wherein said monocrystalline silicon is doped.

50. The method of claim 37, wherein said at least 1 reflecting layer comprises at least 1 metallic layer.

51. The method of claim 37, wherein said at least 1 reflecting layer comprises at least 1 semiconductor layer.

52. The method of claim 37, wherein said at least 1 reflecting layer comprises a plurality of dielectric layers.

53. The method of claim 37, additionally comprising the step of providing a substantially planar surface for the deposition of said at least 1 reflecting layer.

54. The method of claim 37, additionally comprising the step of planarizing the reflecting surface of said reflecting element.

55. The method of claim 54, wherein said step of planarization comprises a chemical mechanical polishing (CMP) step.

56. The method of claim 37, additionally comprising the step of planarizing the reflecting surface of said at least 1 reflecting layer.

57. The method of claim 56, wherein said step of planarization comprises a chemical mechanical polishing (CMP) step.

58. The method of claim 37, additionally comprising the step of forming at least 1 addressing electrode.

59. The method of claim 37, additionally comprising the step of forming control circuitry.

60. The method of claim 59, wherein said control circuitry is formed on said 1st bottom layer.

61. The method of claim 59, wherein said step of forming control circuitry comprises a step of fabricating circuits selected from the group consisting of: CMOS circuits, NMOS circuits, PMOS circuits, bipolar transistor circuits, BiCMOS circuits, DMOS circuits, HEMT circuits, amorphous silicon thin film transistor circuits, polysilicon thin film transistor circuits, SiGe transistor circuits, SiC transistor circuits, GaN transistor circuits, GaAs transistor circuits, InP transistor circuits, CdSe transistor circuits, organic transistor circuits, and conjugated polymer transistor circuits.
